(19) United States
(12) Patent Application Publication
(10) Pub. No.: US 2004/0166386 A1
(43) Pub. Date: Aug. 26, 2004

(54) Fuel cells for exhaust stream treatment

(76) Inventors: Gregory S. Herman, Albany, OR (US); Peter Mardilovich, Corvallis, OR (US); David Champion, Lebanon, OR (US); Christopher Beatty, Albany, OR (US)

Correspondence Address: HEWLETT-PACKARD COMPANY, Intellectual Property Administration, P. O. Box 272400, Fort Collins, CO, 80527-2400, US

(21) Appl. No.: 10/373,310

(22) Filed: Feb. 24, 2003

(51) Int. Cl. H01M 8/06; H01M 8/24; H01M 4/86

(52) U.S. Cl. 429/22; 429/12; 429/9; 429/13; 429/40

(57) ABSTRACT

Subject matter includes a fuel cell and related methods to treat exhaust. An exemplary single chamber fuel cell can produce power while detoxifying multiple exhaust components. The exhaust stream treated can be a combined stream of spent fuel and spent oxidizer.

### TECHNICAL FIELD

This invention relates generally to electrochemical power systems, and more particularly to single chamber fuel cells for exhaust stream treatment.

### BACKGROUND

Electrochemical power supplies such as batteries and fuel cells have become much more practical for portable devices due to increasing ability to produce power efficiently and thus operate longer despite small size. Tiny watch batteries can remain in service five years or more. Fuel cells, like batteries, have benefited from improvements in their design and in the materials from which they are made. For example, solid electrolytes, such as yttria stabilized zirconia (YSZ), have been used successfully in electrochemical cells since the 1940s. More recently, advanced metal oxide ceramic compounds have made portability and miniaturization of fuel cells more possible than ever before. These advances in the ceramic engineering and chemistry of solid electrolytes along with similar advances in the chemical and physical properties of electrodes have resulted in fuel cells being used in a wider variety of applications.

Unfortunately, fuel cells are still not 100% efficient at converting chemical to electrical energy (40-60% is usual). Fuel cells can use hydrocarbon fuels, such as methane, butane, propane, natural gas, methanol, and even gasoline, (with the help of reformers) but since fuel utilization is limited, unoxidized fuel components go untapped and are discarded as waste products in the fuel cell exhaust. The exhaust, i.e., the “spent fuel,” usually contains a mixture of raw unreacted fuel (the hydrocarbon fuel), completely combusted fuel (e.g., carbon dioxide and water), partially combusted fuel (e.g., carbon monoxide), reformed fuel products (e.g., hydrogen), other miscellaneous by-products (e.g., alcohols, aldehydes), and of course, heat. If the spent fuel and spent oxidizer streams exiting a fuel cell are allowed to mix, then of course the exhaust may also include a large percentage of oxygen or air. Thus, fuel cell exhaust somewhat resembles exhaust from other combustion sources, such as automobile engines, factory smokestacks, fossil fuel power plants, etc.

This exhaust from automobiles, smokestacks, fossil fuel power plants, and fuel cells contains untapped resources. The untapped resources, however, are usually not viewed as resources but as pollutants, since they are discarded into the environment as dirty and harmful chemicals that are toxic to people, animals and plants.

### SUMMARY

Described herein are single chamber fuel cells and related methods for treating exhaust. An exemplary single chamber fuel cell (SCFC) can produce power while detoxifying multiple exhaust components into clean air components.

### BRIEF DESCRIPTION OF THE DRAWINGS

FIG. 1 is a graphical representation of exemplary single chamber fuel cells (SCFCs) for generating power and detoxifying exhaust for various exhaust sources, according to one implementation of the subject matter.

FIG. 2 is a block diagram of an exemplary SCFC used to treat fuel cell exhaust, according to one implementation of the subject matter.

FIG. 3 is a diagrammatic illustration of an exemplary relationship between the percentage of fuel combustibles in received exhaust and the percentage of fuel combustibles converted to power in an exemplary SCFC.

FIG. 4 is a block diagram of an exemplary SCFC according to one implementation of the subject matter.

FIG. 5 is a graphic representation of an exemplary SCFC according to one implementation of the subject matter.

FIG. 6 is a graphic representation of exemplary anode, cathode, and electrolyte elements of an exemplary SCFC, according to one implementation of the subject matter.

FIG. 7 is a block diagram of an exemplary series of SCFCs, according to one implementation of the subject matter.

FIG. 8 is a block diagram of an exemplary array of SCFCs, according to one implementation of the subject matter.

FIG. 9 is a flowchart of an exemplary method of treating exhaust, according to one implementation of the subject matter.

### DETAILED DESCRIPTION

Overview

Subject matter and related methods include exemplary single chamber fuel cells (SCFCs) that receive an exhaust stream from a combustion source, such as an automobile engine, a fossil fuel power generating plant, or another fuel cell, and produce electricity while facilitating a more complete oxidation of untapped resources and pollution components in the received exhaust stream. An exemplary SCFC not only prevents waste and converts exhaust into a less toxic form, but generates electricity in doing so.

In one implementation, the electrodes and/or catalysts of the exemplary SCFC are selectively “tuned” (i.e., customized, tailored, and/or optimized) to one, many, or all the components in the received exhaust stream to maximize both production of electricity and detoxification (usually by oxidation) of the selected exhaust components. In a further implementation, multiple exemplary SCFCs are staged in series, each specializing in catalysis and power production from one or more selected exhaust components. In yet another implementation, an array of exemplary SCFCs, each having electrodes and/or catalysts tuned to a selected exhaust component, provides a self-tuning “smart” power plant and pollutant purifier that adjusts to whatever components are present in the exhaust stream. This may be accomplished by measuring the power output of each exemplary SCFC element in the array and directing the exhaust stream to those exemplary SCFC elements having an electrical output indicative of high reactivity with the selected exhaust component(s).

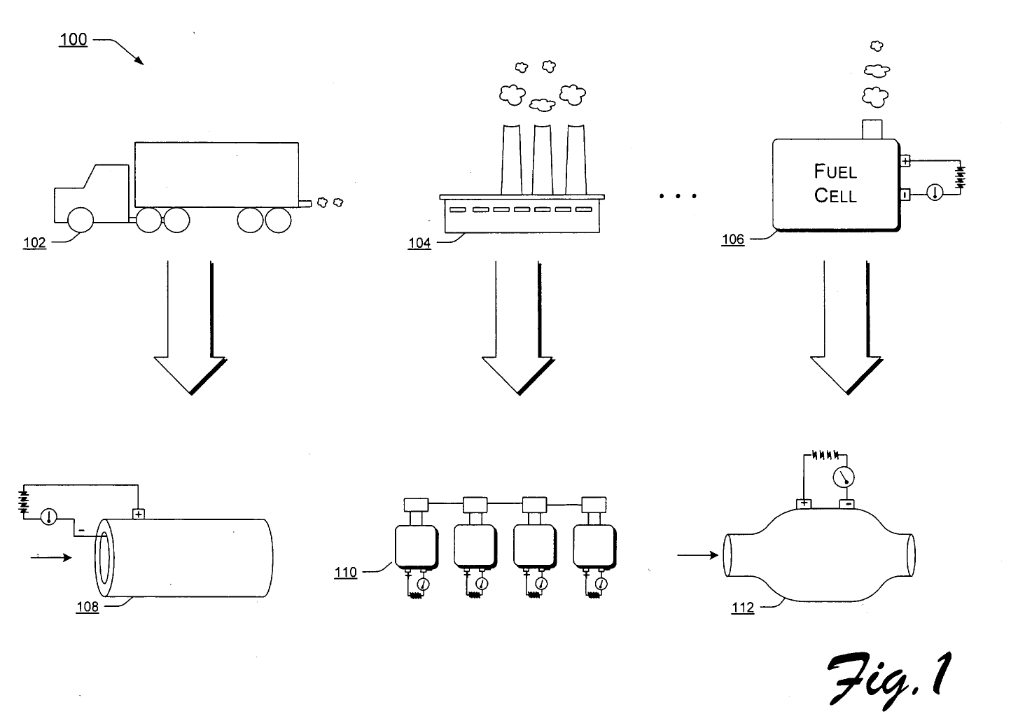

FIG. 1 shows exemplary SCFC treatment 100 of exhaust from combustion sources, such as an automobile 102, a coal gasification plant 104, and a fuel cell 106. Various types and designs of single chamber fuel cells can be enlisted to treat exhaust, depending on the source and composition of the exhaust. For treating the exhaust from an automobile 102, an exemplary tubular SCFC 108 can be used since the preexisting exhaust systems of most automobiles use tubular, linear flow geometries and the exhaust usually consists of a mixture of exhaust components and oxidizer components that can be reacted to advantage in a tubular single chamber design. Industrial exhaust from a factory or power plant, such as a coal gasification plant 104 might be converted to power and detoxified most efficaciously by a large exemplary SCFC 110 or an array of SCFCs of a type that can handle a wide variety of volatile organic compounds in the exhaust. Exhaust from a fuel cell 106, especially a small portable fuel cell, might be well-suited for treatment by a portable, low-temperature, and/or miniaturized SCFC 112. Of course, these matches between exhaust sources 102, 104, 106 and single chamber fuel cell types and geometries 108, 110, 112 are only an example. The type and geometry of the single chamber fuel cell selected will depend on the actual exhaust source and the composition of the exhaust, among other factors.

Any of the illustrated exemplary SCFCs 108, 110, 112 may be a solid oxide fuel cell, a proton conducting ceramic fuel cell, an alkaline fuel cell, a polymer electrolyte membrane (PEM) fuel cell, a molten carbonate fuel cell, a solid acid fuel cell, a direct methanol PEM fuel cell, or other types of fuel cells known to those skilled in the art. Each of these types of fuel cells has an electrolyte and electrodes, which will now be generally described,

An exemplary electrolyte may be formed from any suitable electrolytic material. Various exemplary electrolytes include oxygen anion conducting membrane electrolytes, proton conducting electrolytes, carbonate (CO₃²⁻) conducting electrolytes, OH⁻ conducting electrolytes, hydride ion (H⁻) conducting electrolytes, and mixtures thereof.

Other exemplary electrolytes include cubic fluorite structure electrolytes, doped cubic fluorite electrolytes, proton-exchange polymer electrolytes, proton-exchange ceramic electrolytes, and mixtures thereof. Further, an exemplary electrolyte can also be yttria-stabilized zirconia, samarium doped-ceria, gadolinium doped-ceria, LaₐSr_{b}Ga_{c}Mg_{d}O_{3-∂}, and mixtures thereof, which may be particularly suited for use in single oxide fuel cells.

Exemplary anodes and exemplary cathodes for the SCFCs 108, 110, 112 typically sandwich an electrolyte, such as a solid oxide electrolyte. The anode and cathode may be formed from any suitable material, as desired and/or necessitated by a particular end use. Various exemplary anodes and/or cathodes can be metal(s), ceramic(s) and/or cermet(s). Some non-limitative examples of metals which may be suitable for the exemplary anode include at least one of nickel, platinum and mixtures thereof. Some non-limitative examples of ceramics which may be suitable for an anode include at least one of CeₓSm_{y}O_{2-∂}, CeₓGd_{y}O_{2-∂}, LaₓSr_{y}Cr_{z}O_{3-∂}, and mixtures thereof. Some non-limitative examples of cermets which may be suitable for an anode include at least one of Ni—YSZ, Cu—YSZ, Ni—SDC, Ni—GDC, Cu—SDC, Cu—GDC, and mixtures thereof.

Some non-limitative examples of metals which may be suitable for a cathode include at least one of silver, platinum and mixtures thereof. Some non-limitative examples of ceramics which may be suitable for a cathode include LaSrMnOₓ, LaSrCoFeOₓ, SmₓSr_{y}CoO_{3-∂}, BaₓLa_{y}CoO_{3-∂}, and GdₓSr_{y}CoO_{3-∂}.

An exemplary exhaust flow may contain a hydrocarbon fuel suitable for generating electricity, for example, methane (CH₄), hydrogen (H₂), or other hydrocarbon fuels suited to particular electrode compositions used in fuel cells, i.e., ethane, butane, propane, natural gas, methanol, and even gasoline.

Solid Oxide SCFCs

There are several varieties of solid state fuel cells. The solid polymer membrane fuel cells mentioned above are sometimes considered solid state, but like molten carbonate and phosphoric acid varieties, these rely on water to maintain ionic conductivity. Solid oxide fuel cells are truly solid state since they require no liquid phase at all to transport charged anions from one electrode-electrolyte interface to the other. Conventional solid oxide fuel cells, however, can require high operating temperatures. The operating temperature is often around 1000° C. (about 1800° F.) in order for a single solid oxide fuel cell to produce a voltage between 0.6 to 0.8 volts at a useful current. Certain types of solid oxide SCFCs, however, can be operated at lower temperatures than conventional solid oxide fuel cells.

Solid oxide fuel cells facilitate cell system design since some types of corrosion are eliminated and the electrolyte has no parts or phases that need replacing (solid electrolytes can crack, but they cannot leak out of the assembly or result in the blocking of fluid transport channels as there are no liquid species present). Without a liquid phase to care for, solid oxide fuel cells can be produced in a myriad of configurations.

One aspect of configuration involves how the electrodes, electrolyte, and conductive collectors of the solid oxide fuel cell are deployed to expose the electrodes to fuel and oxidizer. In a dual chamber design, fuel is presented only to the anode, and oxidizer is presented only to the cathode in separate compartments. In the solid oxide SCFC design, fuel and oxidizer can be mixed beforehand and are presented to both anode and cathode at once. The composition of the electrodes in the solid oxide SCFC design allows each anode and cathode to direct its own electrochemical and catalysis reactions due to the selectivity of the electrodes to specific reactions.

The solid state nature of solid oxide SCFCs allows flexible design geometry. A bipolar design has planar parallel plates—a “stack”—and the fuel components, such as hydrogen, natural gas, propane, methanol, etc., and the oxidizer (oxygen, air, etc.) are mixed and directed across the surfaces of plate electrodes. On each side of a plate electrode, one face is exposed to the fuel and oxygen mixture, and the other side is exposed to the electrolyte.

In a radial design for solid oxide SCFCs, the fuel and the oxygen mixture is not passed in an open flow along electrode surfaces, but diffuses through the porous microstructure of disk electrodes from disk center to periphery. In tubular designs, concentric pipes of different diameters comprise the electrodes, electrolyte, and conductors, and also define passageways for the reactant gases and exhaust products. Monolithic designs place repeating assemblies of electrodes and electrolyte on a single substrate, i.e., alternating anode and cathode compartments within a single layer of manufactured ceramic material.

The reactions in solid oxide SCFCs begin with potential fuel molecules and oxidizer molecules adsorbing to electrode surfaces. In the case of oxygen as the oxidizer, the oxygen molecules adsorb to the cathode then diffuse through the cathode, at some point getting reduced to oxygen anions by gain of electrons, as shown in Equation (1), from the electronic current incoming through the cell's electrical circuit (i.e., through the wire or metallic interconnect that connects the anode and cathode):

O₂+4e−→2O²⁻ (1)

The oxygen anions, each having a double negative charge, are the usual ionic species that carry negative charges through the solid oxide electrolyte. Typically the migration of these oxygen anions across the electrolyte is described as a hole hopping mechanism related to the oxygen vacancies in the crystal lattice of the solid metal oxide.

In the anode, the negative charges carried by the oxygen anions reach a potential fuel (e.g., hydrogen), that can be oxidized into reaction products, such as water, as shown in Equation (2), yielding electrons that make up the electrical current produced by the solid oxide SCFC:

H₂+O²⁻→H₂O+2e− (2)

Exemplary SCFC for Exhaust Treatment

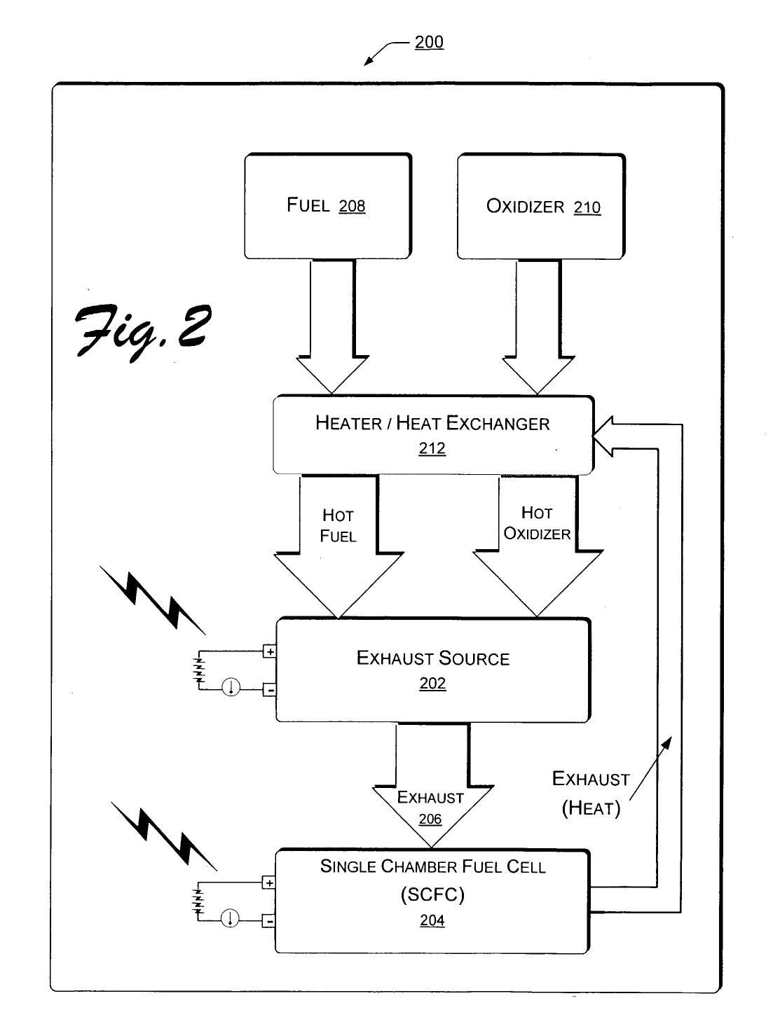

FIG. 2 shows an exemplary power producing system 200 having a fuel cell or other exhaust source (hereafter “exhaust source”) 202 enlisted to produce electricity, and an exemplary SCFC 204 coupled to receive exhaust 206 from the exhaust source 202. In this system 200, the fuel 208 and oxidizer 210 for the exhaust source 202 are heated beforehand by a heater/heat exchanger 212 coupled, in the case of a fuel cell, to the anode and cathode compartments of the exhaust source 202.

The SCFC 204, like the exhaust source 202, is not completely efficient at converting fuel to power. In fact, the SCFC 204 may have less overall efficiency (for example, approximately 40-60% efficiency) at converting fuel to electricity than the exhaust source 202. Even if this is the case, the SCFC 204, however, may be more efficient than the exhaust source 202 at oxidizing fuel species that the exhaust source 202 cannot oxidize and/or selectively targeting components of the exhaust 206 for oxidation that the exhaust source 202 cannot target.

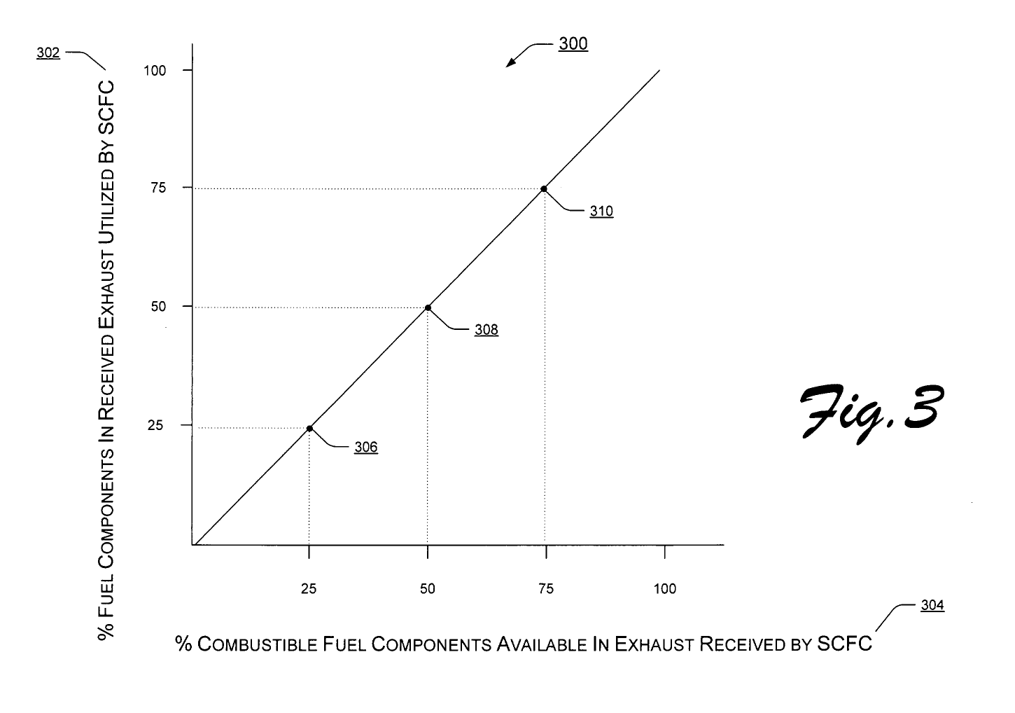

FIG. 3 shows exemplary exhaust utilization 300 of the exemplary SCFC 204 relative to the amount of usable fuel components in received exhaust 206. The “percentage of fuel components in the received exhaust utilized by the SCFC” 302 is plotted against the “percentage of fuel components available in the received exhaust” 304. The latter percentage is roughly the same as the amount of unoxidized fuel species in the exhaust 206 coming from the exhaust source 202. The fuel utilization of the exhaust source 202 can vary, of course, depending on the type of exhaust source 202 and its efficiency (e.g., automobile versus factory smokestack; poorly tuned automobile versus precisely tuned automobile). If the exhaust source 202 is inefficient at utilizing fuel, then the exhaust likely contains more fuel to be utilized by the SCFC 204.

The chemical to electrical conversion efficiency of a fuel cell can be somewhat limited by losses related to, for example, polarization of the electrodes and electrical resistance of the electrolyte. Also, the conversion of the chemical potential energy of the fuel to electrical work results in some losses as well, where ΔG/ΔH is typically defined as the theoretical maximum efficiency. The chemical potential energy of the fuel cannot be completely converted into electrical work. In practice, the efficiency of a fuel cell (including theoretical and experimental losses) is defined as the (operating voltage)/(open circuit voltage), and depending on the type of fuel cell this can be on the order of 30-50%. This is not taking into account fuel utilization.

Fuel utilization describes how much fuel is put into a fuel cell and how much comes out in the exhaust without being completely converted to final reaction products. Ideally, a fuel cell, or other exhaust source 202 for that matter, runs at the highest fuel utilization possible. But in the case of fuel cells, as fuel utilization increases to a high level, electrode polarizations can also increase to a high level and result in decreased chemical to electrical conversion efficiency.

The exemplary SCFC 204 has electrodes optimized to reduce these polarization losses and thus treat the fuel that has not been completely utilized by the exhaust source 202. Ideally both the exhaust source 202 and the exemplary SCFC 204 can be optimized as a system to reduce losses and increase overall efficiency.

If the exhaust source 202 has a fuel utilization efficiency of 75% then up to 25% of the fuel components might still be available in the exhaust from the exhaust source 202 to be utilized by the exemplary SCFC 204. The exemplary SCFC 204 ideally utilizes close to 100% of these incoming fuel components, as shown by the first data point 306 on the graph. If the exhaust source 202 is less efficient, with a fuel utilization of perhaps 50% instead of 75%, then up to 50% of the fuel components might still be available in the exhaust from the exhaust source 202 to be utilized by the exemplary SCFC 204. The exemplary SCFC 204 ideally utilizes close to 100% of these incoming fuel components, as shown by the second data point 308 on the graph. Again, if the exhaust source 202 is even less efficient, with a fuel utilization of perhaps 25% instead of 75% or 50%, then up to 75% of the fuel components might still be available in the exhaust from the exhaust source 202 to be utilized by the exemplary SCFC 204. The exemplary SCFC 204 ideally utilizes close to 100% of these incoming fuel components, as shown by the third data point 310 on the graph. The exemplary SCFC 204 is able to utilize exhaust(s) having varying percentages of fuel components. Whether the fuel mixture in the exhaust is rich or lean, the exemplary SCFC 204 can attain high fuel utilization.

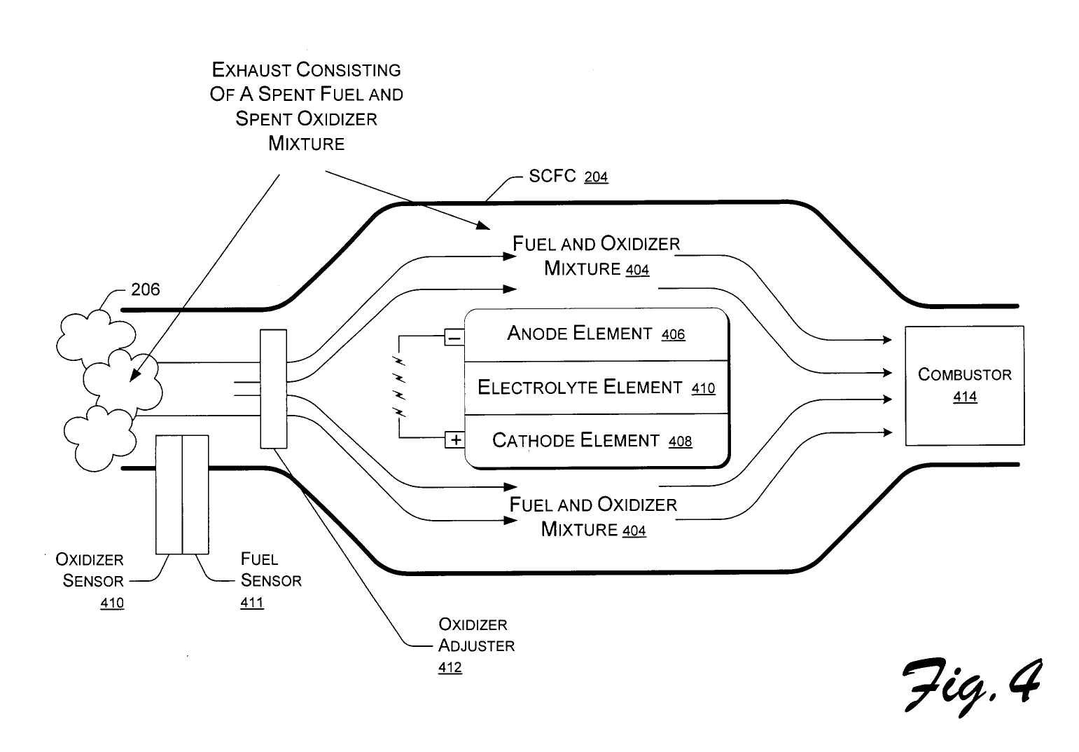

FIG. 4 shows exhaust flow through an exemplary SCFC 204. The exhaust 206 contains unoxidized fuel and fuel species, as discussed above, which the exhaust source 202 did not or could not oxidize. The exhaust 206 also contains oxidizer (from a “spent” oxidizer stream) that is mixed with the unoxidized fuel and fuel species. The fuel and oxidizer mixture 404 is directed to flow freely over an anode element 406 and a cathode element 408 of the SCFC 204. (“Element” as used here means one or more electrode parts or phases.) An electrolyte element 410 of the SCFC 204 is usually disposed between the anode element 406 and the cathode element 408.

The solid oxide type SCFC 204 is particularly suited to treat exhaust 206 because the spent fuel stream and the spent oxidizer stream comprising the exhaust 206 do not need to be kept separate, but can be mixed together in a wide range of proportions. Further, the fuel and oxidizer mixture 404 can be directed to both the anode element 406 and cathode element 408 of the solid oxide SCFC 204 without having to differentiate between the two types of electrodes. However, during construction of a solid oxide SCFC 204, the materials or other characteristics of the electrodes may need to be selected for reaction specificity (i.e. fitted to the type of fuel components in the exhaust, e.g., so that no reduction of oxygen occurs at the anode and no oxidation of the fuel occurs at the cathode). In one implementation of the subject matter, the selectivity of an electrode toward one or more fuel components in the exhaust is achieved by running the SCFC 204 containing the electrode at an optimum temperature for targeting the one or more fuel components.

In another implementation of the subject matter, the specificity of an electrode toward a fuel component is achieved by monitoring and/or controlling the amount of oxidizer in the exhaust 206 being received by the SCFC 204. The ratio of fuel to oxidizer can sometimes control the performance of an exemplary SCFC 204. An excess of oxygen in the exhaust, for example, can often result in combustion of fuel components before they can be utilized to produce electricity. In one implementation, an oxidizer sensor 410 and/or a fuel sensor 411 sample exhaust 206 entering the exemplary SCFC 204. Such sensors are well known, for example, in the automotive and other arts. If the sensed ratio of fuel to oxidizer is too low (too much oxidizer) an oxidizer adjuster 412 may be employed to improve the ratio. The oxidizer adjuster 412 may comprise an oxidizer sorption and redirecting mechanism and/or membrane. A precombustor can also be used in some circumstances to reduce the oxidizer in the exhaust 206. If the ratio is too high (too much fuel in the exhaust 206) then the oxidizer adjuster 412 can be an oxidizer inlet, such as an air injector, etc. Some exhaust sources 202 have separate spent fuel and spent oxidizer outlets (e.g., a dual chamber fuel cell exhaust source 202) so the exhaust 206 can be custom tailored for the exemplary SCFC 204, that is, an optimal amount of the spent oxidizer can be combined with the spent fuel and the remainder of the oxidizer discarded.

In one implementation of the subject matter, an optional combustor 414 is used at an exhaust outlet of the exemplary SCFC 204 to completely oxidize/detoxify any fuel components that have not already been combusted or converted to electrical power in the exemplary SCFC 204.

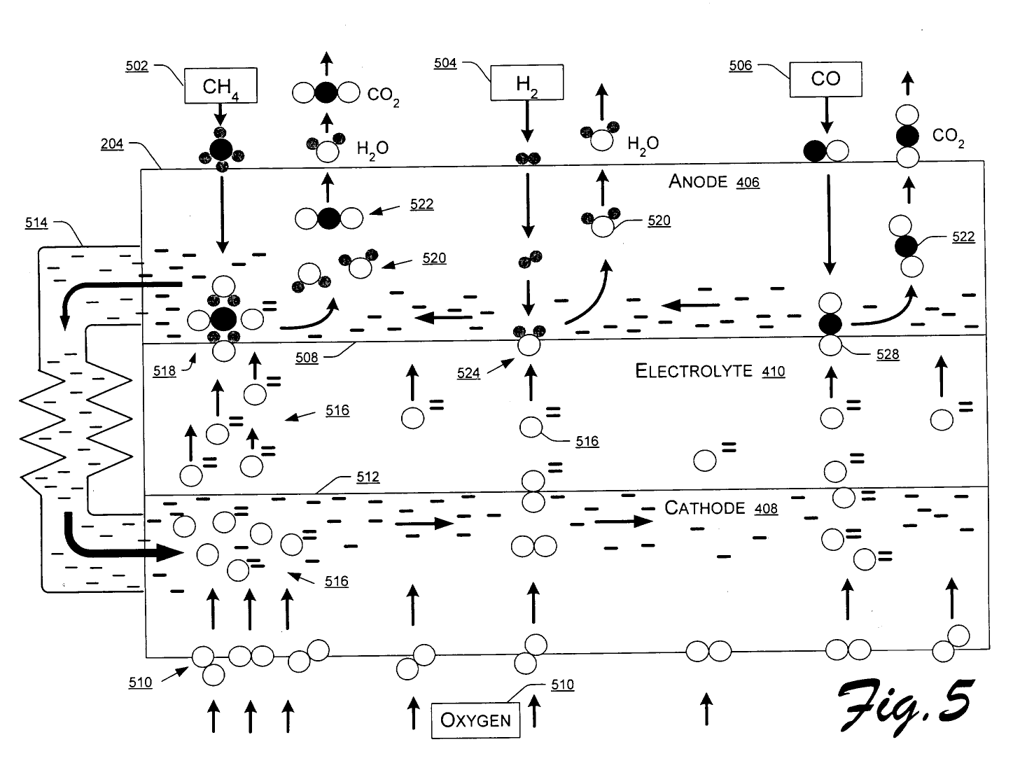

FIG. 5 shows in greater detail an exemplary SCFC 204 for use in exhaust treatment. The anode element 406 and cathode element 408 surround or “sandwich” the electrolyte element 410. The SCFC 204 is bathed in exhaust, that is, the “fuel and oxidizer mixture 404” are received as a mixture of exhaust and oxidizer from the exhaust source 202. Because of the composition and/or form of the electrodes in the SCFC 204, the SCFC 204 can often oxidize a greater selection of exhaust components than the fuel cell exhaust source 202, and/or can be tuned to selectively oxidize one or more particular exhaust components more efficiently than the exhaust source 202.

Catalysts can be added to facilitate the production of more electricity. In one implementation, however, one or more catalysts may be used to oxidize exhaust components without producing electricity, i.e., to detoxify polluting exhaust components through oxidation without generating power via electrochemical reactions. These types of catalysts, for example, finely divided platinum, rhodium, ruthenium, palladium, nickel, copper as well as cermets and alloys that include these metals may be used to oxidize and thereby detoxify exhaust components without making electricity.

The illustrated exemplary SCFC 204 shows the oxidation of three exhaust components: methane (CH₄) 502, hydrogen (H₂) 504, and carbon monoxide (CO) 506. Methane 502, which is used here as a representative hydrocarbon fuel for the exhaust source 202, becomes a fractional component of the exhaust 206, i.e., a fraction passes through the exhaust source 202 without being oxidized. The hydrogen 504 may be present as a reformed by-product of a hydrocarbon fuel that was used to power the exhaust source 202. Carbon monoxide 506 is a partially oxidized by-product of the methane 502 oxidation in the exhaust source 202. In some implementations, the exemplary SCFC 204 can oxidize more than three exhaust components, whereas a dual chamber exhaust source 202 might be able to oxidize only one fuel component efficiently. The SCFC 204 can be configured to oxidize particular exhaust components better than many fuel cells or other exhaust sources 202 used to produce power. The SCFC 204 may be less efficient than many fuel cells or other exhaust sources 202, but better at generating electricity from exhaust 206 and clearing the exhaust 206 of incompletely oxidized pollutants.

At the anode element 406, the methane 502 adsorbs to the anode surface(s), which are usually porous, and diffuses toward the anode-electrolyte interface. At the cathode element 408, oxygen molecules 510 adsorb to the surface(s) of the cathode, which is also usually porous, and diffuse toward the cathode-electrolyte interface 512. It should be noted that in an exemplary SCFC 204, the oxygen molecules 510 are present at both anode and cathode and likewise, the various fuel species and other exhaust components are also present at both anode and cathode. The illustration omits showing the fuel and oxidizer mixture 404 at each electrode in order to more clearly describe the electrochemical reduction-oxidation (redox) reactions. It should also be noted that at any place on the surface(s) of the SCFC 204 the fuel and oxidizer mixture 404 may combust spontaneously (or with the assistance of an added catalyst) without entering into the electrochemical redox reaction(s) of the SCFC 204 that produce electrical power. This is also useful, as mentioned above, because the SCFC 204 has multiple functions besides producing electricity, for example completing oxidation of exhaust components/pollutants and in some implementations, providing heat for preheating fuel and/or oxidizer for a fuel cell to run at an optimum temperature.

As the oxygen molecules 510 diffuse through a porous cathode 408 toward the cathode-electrolyte interface 512, they become exposed to incoming electrons from the cell's external electrical circuit 514, and capture the electrons to become oxygen anions (O²⁻) 516. The oxygen anions 516 migrate to the anode-electrolyte interface 508 to complete the electrical circuit due to the chemical potential gradient where oxygen ions at the cathode migrate to replace the oxygen ions consumed in the production of water 520 and carbon dioxide 522 at the anode element 406. When the oxygen anions 516 and the methane 502 (or other fuel) meet (518) at the anode-electrolyte interface 508, the methane 502 combines with oxygen anions 510—an oxidation reaction—to form reaction products, such as water 520 and carbon dioxide 522. Electrons are left over once the reaction products have formed. Two electrons are lost each time an oxygen anion 516 combines with either a carbon atom or two hydrogen atoms of the methane 502. The lost electrons originate the electric current that may be harnessed via the cell's external electrical circuit 514. The water 520 and carbon dioxide 522 diffuse toward the outer surface(s) of the anode element 406 and return to the exhaust stream when they leave the surface of the anode element 406.

The hydrogen 504 undergoes an oxidation in the SCFC 204 similar to that of the methane 502. Molecules of the hydrogen 504 adsorb onto the surface(s) of the anode element 406 and diffuse toward the anode-electrolyte interface 508. In the anode element 406, a molecule of hydrogen 504 combines (524) with an oxygen anion 516 to form water 520. Two electrons are freed for each oxygen anion 516 used in the reaction. The water 520 migrates out of the anode element 406 and back into the fuel and oxidizer mixture 404.

Carbon monoxide 506, another exhaust component from the exhaust source 202, also adsorbs onto the surface(s) of the anode element 406 and diffuses toward the anode-electrolyte interface 508. In the anode element 406, the carbon monoxide 506 combines (528) with an oxygen anion 516 to form carbon dioxide 522. Two electrons are freed for each oxygen anion 516 used in the reaction. The carbon dioxide 522 migrates out of the anode element 406 and is released back into the stream of fuel and oxidizer mixture 404.

To summarize briefly, the exemplary SCFC 204 is well-suited to generate electricity from (and detoxify) the exhaust 206 because fuel components of the exhaust 207 do not need to be kept isolated from the oxidizer components and because the SCFC 204 can oxidize a wide selection of exhaust components from a exhaust source 202. Certain aspects of the exemplary SCFC 204 can be adjusted or “tuned” to maximize the production of electricity from exhaust components and maximize the detoxification of pollutants.

Tuning a SCFC for Exhaust Treatment

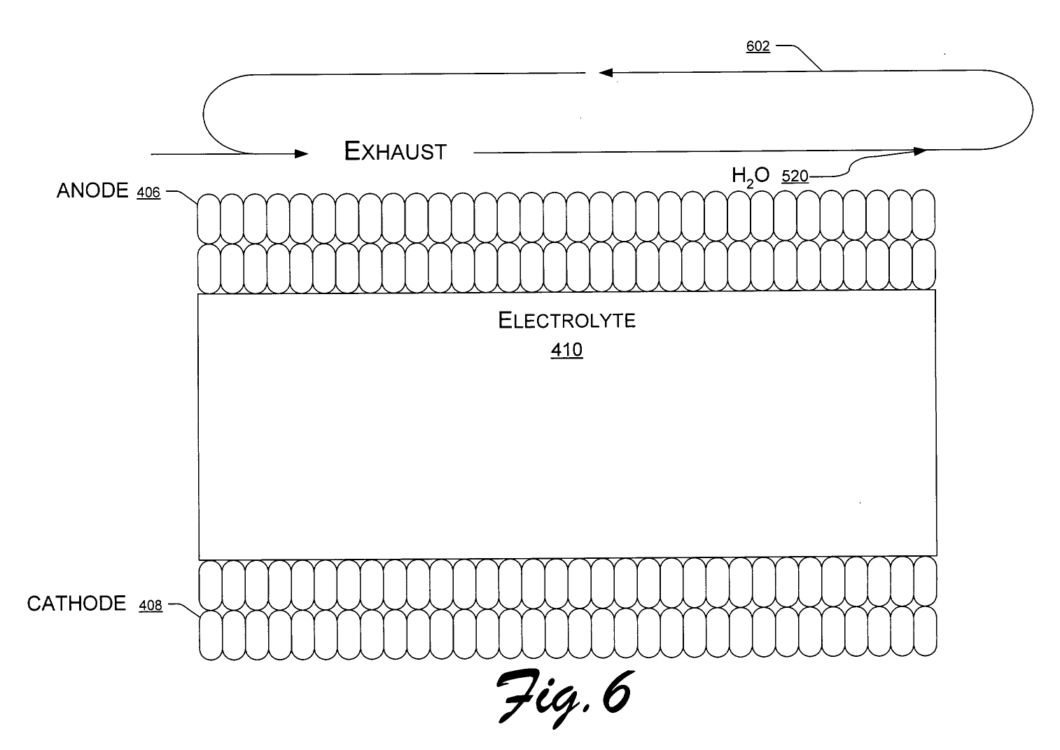

FIG. 6 shows another view of the exemplary SCFC 204 for treating exhaust. The anode element 406 is depicted as a deposited layer on the electrolyte element 410, e.g., a solid oxide electrolyte element. The cathode element 408 is also depicted as a deposited layer on another face of the electrolyte element 410.

The anode element 406, cathode element 408, and electrolyte element 410 can be thin (1-1000 micron) layers deposited, plated, sputtered, annealed, etc. onto each other to form the layers shown in the exemplary SCFC 204. The thermal expansion coefficients of these layers (and other layers if surface catalysts are added as additional layer(s)) must be substantially matched to avoid cracking and/or separation of the layers, although SCFCs often operate at lower temperatures than some dual chamber fuel cells. The ceramic and/or solid oxide electrolyte (e.g., samaria doped ceria: SDC) exhibits sufficient oxygen anion conductivity and small enough electronic conductivity at 500° C. to be practical for use in a SCFC 204 for treating exhaust.

The electrodes can be porous gas diffusion electrodes, however, the porosity and/or surface area of the anode element 406 can be increased to maximize contact with exhaust gases. This increase in anode surface area may also be accomplished, of course, by using a large or relatively oversized exemplary SCFC 204.

In one implementation, the anode element 406 can have approximately 20-40% porosity and can be formed from metallic nickel and a SDC skeleton that has a similar coefficient of thermal expansion to the other elements. The nickel component not only conducts the electrical current, but also serves as a catalyst. This type of anode element 406 results in a SCFC 204 that is tolerant of fuel impurities and various exhaust components and can generate electricity using such species as hydrogen 504, carbon monoxide 506, and relatively inert hydrocarbons, such as methane 502. The relatively high operating temperatures combined with an exemplary anode element 406 that includes nickel also enables internal reforming of methane 502 to hydrogen 504 to take place within the anode compartment of the cell, as shown in Equation (3):

CH₄+H₂O→CO+3 H₂ (3)

To tune the anode element for increased capacity to oxidize methane, the H₂O for the reforming reaction of Equation (3) can be increased by recirculating 602 exhaust from the anode element 406 back to the inlet of the exemplary SCFC 204 for a recycle of the H₂O over the anode element 406. If the exhaust is recirculated in this way, then no external reformer devices and/or catalysts are required to break down more methane 502 and produce hydrogen 504 in this manner other than the anode element 406 itself.

The relatively high operating temperatures in some SCFCs 204 and/or added catalysts lower the activation polarization resulting in high reactant activity, fast electrode kinetics, and thus relatively large electrical currents per unit area. Electrode reactions may still be the rate limiting step in the overall electrochemical operation of the exemplary SCFC 204, but with a high operating temperature the rate limiting is not due to the kinetics of activation overpotentials, but to the electrical resistance of charges crossing the anode-electrolyte interface and the cathode-electrolyte interface.

The exemplary SCFC 204 is not only not poisoned and/or clogged by exhaust components that are detrimental to some other types of fuel cells, but can use many of the offending exhaust components, such as carbon monoxide (CO) and sulfur compounds (for example, using a sulfur conducting membrane to separate the sulfur containing compounds) to generate electricity. This, of course, is of considerable advantage when using the exemplary SCFC 204 to treat not only fuel cell exhaust, but also automobile exhaust, biomass gases, or by-products of coal gasification.

This basic recipe for composition of the anode element 406 can be made more highly activated, as will be discussed more fully below. The cathode element 408 can be made from suitable high-temperature and oxidation resistant materials, such as samarium cobaltite doped with strontium, and the cathode element 408 can have approximately the same porosity (20-40%) as the anode element 406. If several exemplary SCFCs 204 are stacked in series, then the interconnects between the cells can be made from lanthanum chromite doped with strontium or a suitable high temperature metal alloy.

The activity of the electrodes can be increased further by adding electrocatalytic agents, such as platinum and/or palladium, etc. Catalytic agents can be added either as an alloy or as a surface coating to effect catalytic conversion of exhaust components. To tune the exemplary anode element 406, cathode element 408, and/or electrolyte element 410 for increased capacity to produce power and/or oxidize a particular exhaust component, the method of combining materials for making an electrode or the electrolyte is as important as the materials themselves. Hibino et al., for example, describe the electrocatalytic oxidation of methane in single chamber fuel cells, such as the exemplary SCFC 204, using a samaria doped ceria (SDC) electrolyte element 410, (i.e., Ce_{0.8}Sm_{0.2}O_{1.9}), a Sm_{0.5}Sr_{0.5}CoO₃ cathode element 408, and an anode element 406 having a composition of 0-10 percent by weight metal oxide (PdO, PtO, Rh₂O₃, or RuO₂), and 30 percent by weight NiO cermets containing SDC. (Hibino, Hashimoto, Yano, Suzuki, Yoshida, and Sano, “High Performance Anodes for SOFCs Operating in Methane-Air Mixture at Reduced Temperatures,” Journal of the Electrochemical Society, 149 (2) A133-A136, 2002, incorporated herein by reference.)

Various improved electrolytes for single chamber fuel cells are also described by Hibino, Hashimoto, Inoue, Tokuno, Yoshida, and Sano in “A Low-Operating-Temperature Solid Oxide Fuel Cell in Hydrocarbon-Air Mixtures,” Science, Vol. 288, Jun. 16, 2000, which is also incorporated herein by reference.

High activity electrodes tuned to oxidize carbon monoxide (for example, to provide hydrogen-rich exhaust to the exemplary SCFC 204) can be constructed using a Pt/alumina mixture, or by using catalysts based on cerium oxide: for example nanosized gold ceria or copper ceria. Nanosized gold on a reducible oxide has high catalytic activity in many important oxidation reactions, including carbon monoxide oxidation and the water gas shift reaction (see Q. Fu, S. Kudriavtseva, H. Saltsburg, and M. Flytzani-Stephanopoulos, “Gold-ceria Catalysts for Low Temperature Water-gas Shift Reaction.” Chem. Eng. J., 87 (3), 2002, incorporated herein by reference).

To increase the surface area of the electrode(s) for increasing the adsorption of exhaust components, the porosity or the electrode elements may be increased and/or the roughness of the surface areas may also be increased, e.g., by depositing catalysts in as finely divided a state as possible or practical.

Stacked and/or interconnected SCFCs 204 can also increase surface area for oxidizing exhaust components through an increase in the number of electrodes available. In one implementation, a monolithic tubular design (e.g., a modified version of the Westinghouse design for a fuel cell stack: http://www.fe.doe.gov/techline/tl_sofc1.html) can be employed using, for example, one millimeter diameter tubes. Of course, all these methods of increasing electrode surface area can be combined simultaneously.

The size of exemplary SCFCs 204 suitable for treating exhaust streams is not limited to relatively large power producing systems. Photolithography may be used to yield fuel cell components with approximately one micron resolution, resulting in fuel cells on a substrate approximately 50×50 microns in area.

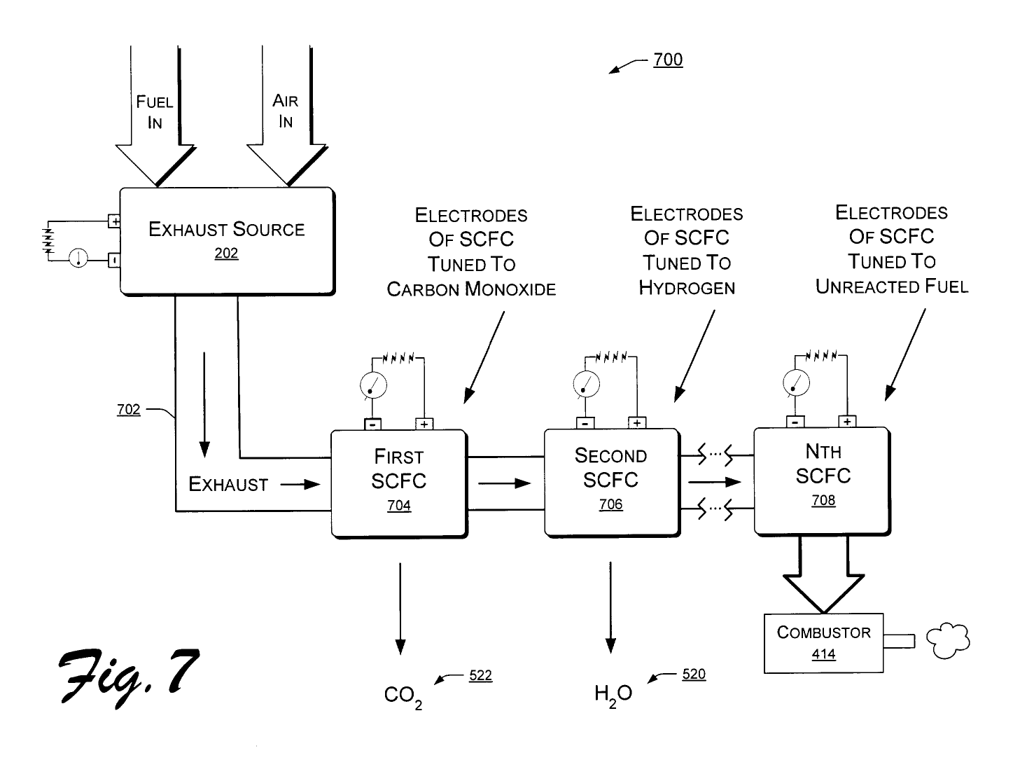

FIG. 7 shows an exemplary power generating system 700 having one or more exhaust sources 202 coupled to an exhaust channel 702. Exhaust from the exhaust source(s) 202 is conducted in sequence to a series of cells, consisting of a first SCFC 704, a second SCFC 706, . . . and an Nth SCFC 708.

The series of SCFCs 704, 706, 708 has individual SCFCs, each tuned to a selected component of the exhaust. Further, the series can be tuned as a group to maximize power generation and detoxification based on the exhaust profile of a particular type of exhaust source 202. For example, if the exhaust is known to contain a relatively high concentration of carbon monoxide 506, then a SCFC, such as the exemplary first SCFC 704, can be employed with electrodes and other characteristics customized to oxidize carbon monoxide 506 to carbon dioxide 522 very efficiently. The anodic material and catalysts, for example, as well as the physical properties of the anode (porosity, tortuosity of pores, etc.) can be selected to yield a highly activated anode relative to carbon monoxide 506. Not only can the first SCFC 704 be tuned for carbon monoxide 506, but a first SCFC 704 can be selected that is larger or has higher capacity (i.e., increased anodic surface area and increased overall cell size) than other SCFCs 706, 708 in the series because of the known high concentration of carbon monoxide 506 in the exhaust. Alternatively, several SCFCs tuned to carbon monoxide 506 might be used to handle the high concentration of carbon monoxide so that a series of SCFCs 704, 706, 708 selective for certain exhaust components are deployed in ratios that match the ratios of the exhaust components.

Likewise, the other SCFCs 706, 708 in the series can each be tuned to one or more particular exhaust components. The second SCFC 706, for example, can be tuned to hydrogen 504 (i.e., a second SCFC 706 is selected that oxidizes hydrogen 504 to water 520 very efficiently) and the Nth SCFC 708 can be tuned to another exhaust component, such as the unreacted fraction of the original fuel for the primary fuel cell 202. Of course, the illustrated order of placing tuned SCFCs 704, 706, 708 to receive exhaust is only an example, the SCFCs 704, 706, 708 can be placed in any order to receive the exhaust. Further tuning to exhaust ingredients can be performed by modifying the anode composition and/or operating temperature of individual SCFCs.

In one implementation, the series of SCFCs 704, 706, . . . 708 can include SCFCs tuned to many possible exhaust components, forming a general purpose exhaust treatment array that can generate power and detoxify a wide variety of different exhausts. Such an array can include SCFCs each tuned to different common fuels, such as methane, ethane, butane, propane, natural gas, jet fuel, gasoline, methanol, etc., and can further include SCFCs for other anticipated exhaust components, such as carbon monoxide 506, hydrogen 504, unreacted fuel, alcohols, aldehydes, etc.

In one implementation, a combustor 414 is used at an exhaust outlet of the final exemplary SCFC 204 in the sequence to completely oxidize/detoxify any fuel components that have not already been combusted or converted to electrical power in the exemplary power generating system 700.

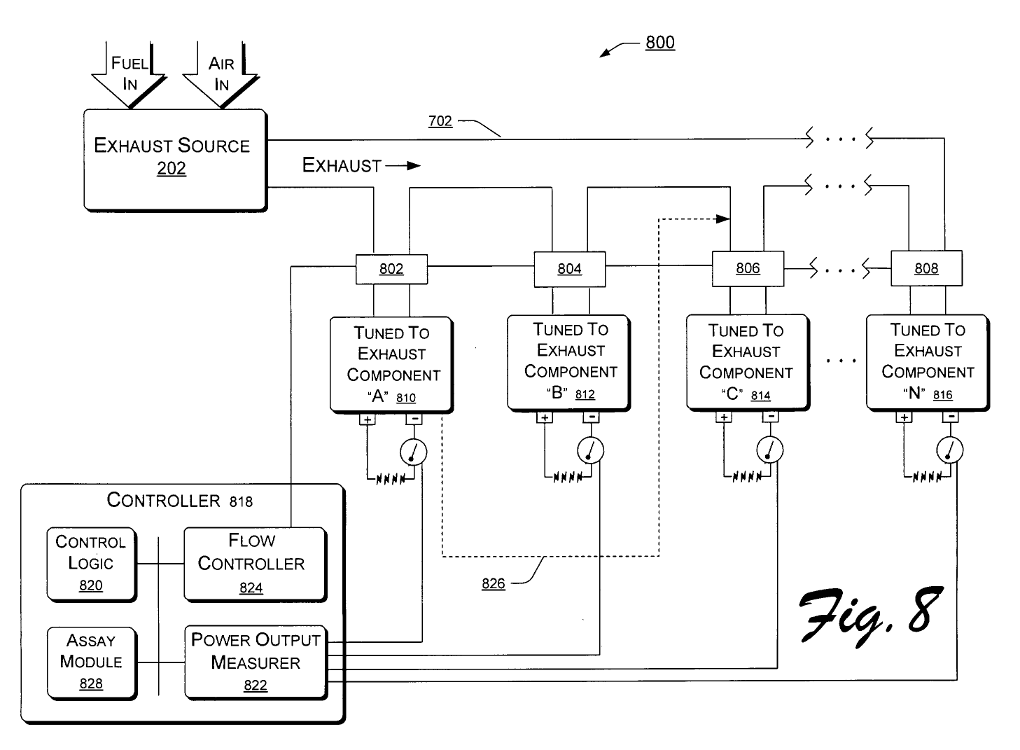

FIG. 8 shows another exemplary power generating system 800 having a exhaust source 202 coupled to an exhaust channel 702 or manifold. The exhaust channel 702 is coupled to an array of SCFCs via flow adjusters 802, 804, 806, 808, such as valves. The first flow adjuster 802 couples a first SCFC 810, tuned to exhaust component “A,” to the exhaust manifold 702; the second flow adjuster 804 couples a second SCFC 812, tuned to exhaust component “B,” to the exhaust manifold 702; the third flow adjuster 806 couples a third SCFC 814, tuned to exhaust component “C,” to the exhaust manifold 702; and an Nth flow adjuster 808 couples an Nth SCFC 816, tuned to exhaust component “N,” to the exhaust manifold 702. The exemplary power generating system 800 also includes a controller 818 having use of control logic 820, coupled with a power output measurer 822 and a flow controller 824. The power output measurer 822 is coupled with the electrical circuit of each SCFC 810, 812, 814, 816. The flow controller 824 is coupled with each flow adjuster 802, 804, 806, 808.

In one implementation of the exemplary power generating system 800, as the exhaust source 202 creates exhaust, the exhaust is directed equally to each SCFC 810, 812, 814, 816 of the array through open flow adjusters 802, 804, 806, 808. Because each SCFC is tuned to a different component of the exhaust, each may produce a different power output. The controller 818 surveys and analyzes the power output and performance of each SCFC 810, 812, 814, 816 as well as the performance of the array as a whole. The performances may be compared with predetermined thresholds or compared with each other and used as criteria for adjusting exhaust flow to the SCFCs 810, 812, 814, 816. For example, if only one SCFC is producing appreciable power, the flow adjusters to all the other SCFC elements of the array may be closed so that all the exhaust is directed to the SCFC tuned to the exhaust component that is significantly producing. In this implementation, it is helpful if each SCFC 810, 812, 814, 816 in the array has the capacity to process all of the exhaust, if necessary. Of course, each SCFC element in an array may consist of multiple SCFCs tuned to the same exhaust component(s).

The controller 818 keeps track of the tuning of each SCFC 810, 812, 814, 816. Hence, if the first SCFC 810 and the third SCFC 814 are producing an equal amount of significant power, but the second SCFC 812 and the Nth SCFC 816 are producing hardly any power, then the controller 818 may close the second flow adjuster 804 and the Nth flow adjuster 808 to direct the exhaust flow to the cells producing the most power.

In some implementations, the controller 818 may recycle (826) the exhaust flow from a first SCFC, such as the first SCFC 810 to the exhaust intake of another SCFC, such as the third SCFC 814 so that SCFCs that are producing a significant amount of power but tuned to different exhaust components can operate on the exhaust stream in sequence. The array of SCFCs 810, 812, 814, 816 is thus automatically tuned by the controller 818 to the profile of the exhaust, resulting in an increased amount of power generated from the same exhaust as compared to exhaust one pass through a single SCFC element that is tuned only to limited components of the exhaust.

The controller 818 can also include an assay module 828. When the power output measurer 822 surveys the power output of each SCFC 810, 812, 814, 816 in the array as exhaust is being directed equally to each, the assay module 828 can plot the power output of each against the exhaust component(s) that each is tuned to. Thus, the assay module 828 can compile and output an assay report showing the composition of the exhaust. It should be noted that the controller 818 can also be coupled independently with emission detectors (e.g., the type used in automobile emission tests) for each SCFC 810, 812, 814, 816 to determine if exhaust exiting each is being oxidized and/or detoxified by non-power producing catalysis. Power production is not always the primary criteria for controlling the SCFC elements in the array, in some circumstances more complete oxidation and/or detoxification of the exhaust components may predominate over power production as the criterion for directing exhaust to various SCFC elements in the array. Of course, the assay module 828 can plot the power-producing reaction(s) of a given SCFC against non-power producing catalysis if independent emissions detectors are used, and present a multifaceted assay report detailing the composition of the exhaust, which exhaust components are producing power, and which exhaust components are being oxidized and/or detoxified.

Method of Treating Exhaust using a SCFC

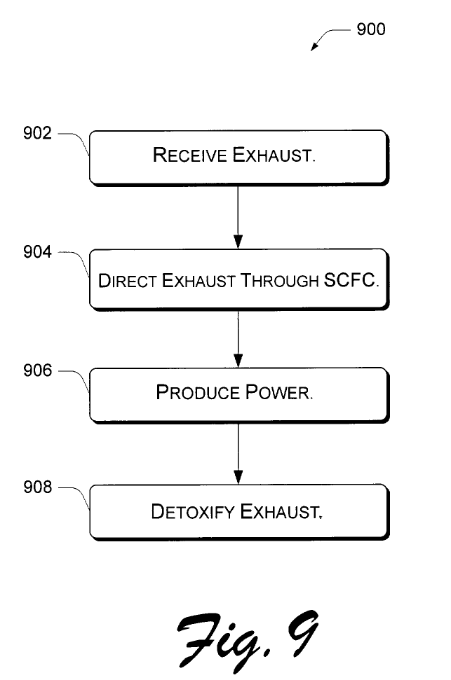

FIG. 9 shows an exemplary method 900 of treating an exhaust stream. In the flow diagram, the operations are summarized in individual blocks. Thus, at block 902, exhaust is received. The exhaust may be from a fuel cell or other exhaust source, such as an automobile exhaust system or a factory smokestack etc.

At block 904, the exhaust is directed through a SCFC. Since the electrodes of a SCFC can direct their own reactions without being appreciably hindered by additional exhaust and/or oxidizer constituents, the exhaust stream does not have to be compartmentalized into a fuel stream for an anodic chamber and an oxidizer stream for a cathodic chamber. The SCFC may have highly activated electrodes tuned to exhaust components and increased electrode surface areas to adsorb the exhaust with more efficiency than conventional electrodes.

At block 906, the SCFC produces power by oxidizing one or more components of the exhaust. The SCFC is well-suited for producing power from exhaust because the power producing redox reactions possible in a SCFC can proceed using a wide variety of fuel and exhaust species, as compared with dual chamber fuel cell modalities.

At block 908, a catalyst detoxifies fuel and/or exhaust components. The catalyst(s) present in a SCFC may be selected, i.e., tuned, to particular fuel and/or exhaust components.

The operations in the exemplary method 900 do not have to be performed in a particular order. Specifically, the detoxification by one or more catalysts may be performed before, during, and/or after the power producing operation. Further, the detoxification by one or more catalysts may be performed without any power producing operation, for example, when a SCFC tuned to a particular exhaust component does not oxidize the component in an electrochemical reaction but oxidizes the component with available oxidizer upon direct physical contact with the catalyst.

Conclusion

The foregoing discussion describes exemplary single chamber fuel cells, exemplary systems, and exemplary methods for treating exhaust. Although the invention has been described in language specific to structural features and/or methodological acts, it is to be understood that the subject matter defined in the appended claims is not necessarily limited to the specific features or acts described.

1. An apparatus for treating exhaust, comprising:
a fuel cell operatively coupled to receive the exhaust; and
an electrode included in the fuel cell capable of participating in one of an electrochemical reaction that uses one or more components of the exhaust as a reactant to produce electricity and a catalytic reaction that uses one or more components of the exhaust in an oxidation-reduction reaction.

2. The apparatus as recited in claim 1, wherein the electrode is an anode.

3. The apparatus as recited in claim 1, wherein the electrode is a cathode.

4. The apparatus as recited in claim 1, further comprising a catalyst to facilitate generating electricity using at least an oxidizable component of the exhaust, wherein the catalyst is selective to one or more components of the exhaust.

5. The apparatus as recited in claim 4, wherein the catalyst converts an oxidizable component of the exhaust into another oxidizable component that can participate in an electrochemical reaction to thereby generate an electrical potential.

6. The apparatus as recited in claim 4, wherein the catalyst facilitates oxidation of a component of the exhaust.

7. The apparatus as recited in claim 1, wherein the electrode produces electricity using multiple oxidizable components of the exhaust and an oxidizer component of the exhaust.

8. The apparatus as recited in claim 1, wherein the electrode is tuned to produce electricity most efficiently when a particular oxidizable component of the exhaust is present.

9. The apparatus as recited in claim 8, wherein the electrode is tuned to produce electricity only when a particular oxidizable component of the exhaust is present.

10. The apparatus as recited in claim 1, wherein the electrode has a surface area large enough to adsorb more than half of the oxidizable components in the exhaust.

11. The apparatus as recited in claim 10, wherein the electrode has a chemical composition that activates an electrochemical reaction for the oxidizable components in the exhaust.

12. The apparatus as recited in claim 1, wherein the fuel cell has a solid oxide electrolyte.

13. The apparatus as recited in claim 1, wherein the exhaust is from one of an automobile engine, a fossil fuel burning power plant, a fuel cell, a coal gasification plant, an oil refinery, a petroleum processing plant, a paper mill, a chemical manufacturing plant, a semiconductor fabrication plant, and an electronics component fabrication plant.

14. The apparatus as recited in claim 1, further comprising one or an oxidizer sensor and a fuel sensor to determine a fuel to oxidizer ratio of the exhaust.

15. The apparatus as recited in claim 14, further comprising an oxidizer adjuster to vary the fuel to oxidizer ratio.

16. The apparatus as recited in claim 15, wherein the oxidizer adjuster is one of an oxidizer adsorber, an oxidizer redirector, an oxidizer sensitive membrane, a precombustor, an oxidizer injector, and an air inlet.

17. The apparatus as recited in claim 1, further comprising a combustor to oxidize components in the exhaust not participating in the electrochemical reaction and the catalytic reaction.

18. A fuel cell for treating an exhaust stream, comprising:
an exhaust inlet to receive the exhaust stream, wherein the exhaust inlet directs the exhaust stream to both an anode side and a cathode side of the fuel cell;
an electrode for use as one of an anode and a cathode of the fuel cell, wherein the electrode uses a component of the exhaust stream to produce electricity; and
an electrical conductor between the anode and cathode of the fuel cell to allow electricity to flow in a circuit.

19. The fuel cell as recited in claim 18, wherein a surface area of the electrode is large enough to adsorb substantially all oxidizable components of the exhaust stream.

20. The fuel cell as recited in claim 18, further comprising a catalyst, wherein the catalyst facilitates a chemical reaction useful for producing electricity.

21. The fuel cell as recited in claim 18, further comprising a catalyst, wherein the catalyst facilitates oxidation of a component of the exhaust stream.

22. The fuel cell as recited in claim 18, wherein the electrode produces electricity using multiple oxidizable components of the exhaust and an oxidizer component of the exhaust.

23. The fuel cell as recited in claim 18, wherein the electrode adsorbs multiple oxidizable components of the exhaust stream to use as fuel for generating electricity.

24. The fuel cell as recited in claim 18, wherein the electrode is tuned to produce electricity most efficiently using a selected oxidizable component of the exhaust stream.

25. The fuel cell as recited in claim 24, wherein the electrode is tuned to produce electricity only when the selected oxidizable component of the exhaust stream is present.

26. The fuel cell as recited in claim 18, wherein the electrode is tuned to produce electricity using a selected oxidizable component of the exhaust stream by operating the fuel cell containing the electrode at a temperature that optimizes selection of the oxidizable component.

27. The fuel cell as recited in claim 18, wherein at least one of the anode and the cathode have a chemical composition that activates an electrochemical reaction for at least most of the oxidizable components of the exhaust.

28. The fuel cell as recited in claim 18, wherein at least one of the anode and the cathode have a physical characteristic that activates an electrochemical reaction for at least most of the oxidizable components of the exhaust.

29. The fuel cell as recited in claim 18, further comprising an outlet to send reaction products of the SCFC to a heat exchanger for preheating fuel for a fuel cell.

30. The fuel cell as recited in claim 18, wherein the exhaust stream is from one of an automobile engine, a fossil fuel burning power plant, a fuel cell, a coal gasification plant, an oil refinery, a petroleum processing plant, a paper mill, a chemical manufacturing plant, a semiconductor fabrication plant, and an electronics component fabrication plant.

31. The fuel cell as recited in claim 18, wherein the exhaust stream is directed at least in part to the anode side and recycled back to the anode side to reform the fuel.

32. The fuel cell as recited in claim 18, wherein the fuel cell has a solid oxide electrolyte.

33. A set of fuel cells for treating an exhaust stream, comprising:
a first fuel cell having an electrode tuned to produce electricity from a first exhaust component; and
a second fuel cell having an electrode tuned to produce electricity from a second exhaust component, wherein the second fuel cell receives the exhaust stream from the first fuel cell.

34. The set of fuel cells as recited in claim 33, further comprising:
a first catalyst in the first fuel cell to facilitate generating electricity from the first exhaust component; and
a second catalyst in the second fuel cell to facilitate generating electricity from the second exhaust component.

35. The set of fuel cells as recited in claim 33, further comprising a catalyst to oxidize exhaust components besides the first exhaust component and the second exhaust component.

36. The set of fuel cells as recited in claim 33, wherein at least some fuel cells in the set have a solid oxide electrolyte.

37. A fuel cell array for treating an exhaust stream, comprising:
multiple fuel cells, wherein each fuel cell has an electrode tuned to produce electricity from one of more specific components of the exhaust stream; and
an exhaust manifold for receiving the exhaust stream and directing parts of the exhaust stream to each fuel cell in the array of fuel cells.

38. The fuel cell array as recited in claim 37, further comprising a flow adjuster between each fuel cell and the manifold to control the flow of exhaust to each fuel cell.

39. The fuel cell array as recited in claim 37, further comprising a power output measurer to determine an electrical power output of each fuel cell in the array.

40. The fuel cell array as recited in claim 37, further comprising a flow controller coupled to each flow adjuster and to the power output measurer to increase the exhaust flow to those fuel cells having high electrical power output.

41. The fuel cell array as recited in claim 37, further comprising an assay module to report the electrical power output of a fuel cell in the array in relation to the one or more specific components of the exhaust stream that the fuel cell is tuned to.

42. A method, comprising:
receiving exhaust from a combustion source;
directing the exhaust through a fuel cell; and
producing electrical power from the exhaust using the fuel cell.

43. The method as recited in claim 42, further comprising detoxifying the exhaust using the fuel cell.

44. The method as recited in claim 42, further comprising producing electrical power using multiple components of the exhaust.

45. The method as recited in claim 44, further comprising using multiple fuel cells to produce electrical power from the exhaust, wherein each fuel cell is tuned to produce electrical power from a different component of the exhaust.

46. The method as recited in claim 45, wherein the multiple fuel cells receive the exhaust in a sequence.

47. The method as recited in claim 45, wherein an exhaust flow is increased to one or more of the multiple fuel cells based on an electrical power output of the one or more fuel cells.

48. A method, comprising:
increasing the surface area of an electrode of a fuel cell to adsorb exhaust components; and
enclosing the electrode in a chamber of the fuel cell, wherein the chamber is shaped to direct the exhaust components to the electrode.

49. The method as recited in claim 48, further comprising selecting electrode materials to produce electricity from a selected exhaust component.

50. The method as recited in claim 49, further comprising adding a catalyst to the electrode materials to oxidize an exhaust component that is not used to produce electricity.

51. A system for treating exhaust from a combustion source, comprising:
a means for receiving the exhaust;
a means for directing the exhaust over an electrode of a fuel cell having an anode and a cathode; and
a means of conducting electricity from the anode to the cathode to form an electric circuit.

52. The system as recited in claim 51, further comprising a means for producing electrical power from the electrode using multiple fuel components in the exhaust.

53. The system as recited in claim 52, further comprising a means for tuning the electrode to produce power from a selected exhaust component.

54. The system as recited in claim 53, further comprising a means of linking multiple single chamber fuel cells to treat fuel cell exhaust, wherein each linked single chamber fuel cell produces power from a selected exhaust component.

55. A power generator, comprising:
A first fuel cell having a first efficiency, wherein the first fuel cell produces an electrical potential by receiving fuel and outputting exhaust; and
a second fuel cell operatively coupled with the first fuel cell, wherein the second fuel cell produces electricity by receiving the exhaust from the first fuel cell.

56. The power generator as recited in claim 55, wherein the second fuel cell detoxifies the exhaust from the first fuel cell using oxidation.

57. The power generator as recited in claim 55, wherein at least one of the first fuel cell and the second fuel cell have a solid oxide electrolyte.

58. The power generator as recited in claim 55, wherein the second fuel cell recycles the exhaust over an electrode of the second fuel cell.
